(19) United States
(12) Patent Application Publication
(10) Pub. No.: US 2026/0370608 A1
(43) Pub. Date: Nov. 19, 2026

(54) TRANSMISSION DEVICE AND RECEPTION DEVICE

(71) Applicant: FDK Corporation, Tokyo (JP)

(72) Inventor: Masanori HOSHINO, Tokyo (JP)

(73) Assignee: FDK Corporation, Tokyo (JP)

(21) Appl. No.: 19/148,335

(22) PCT Filed: Dec. 28, 2023
(86) PCT No.: PCT/JP2023/047336

§ 371 Date: Jul. 16, 2025

(30) Foreign Application Priority Data
Jan. 20, 2023 (JP) 2023-007034

(51) Int. Cl. H04L 47/43; H04L 47/34

(52) U.S. Cl. CPC H04L 47/43; H04L 47/34

(57) ABSTRACT

Provided are a transmission device and a reception device capable of appropriately transmitting and receiving data while suppressing a lack of identifiers. The transmission device divides transmission data into a plurality of frames, stores the frames, and transmits the frames. The transmission device has a frame generation unit that assigns a shared identifier to the plurality of frames, divides a data field different from an identifier storage unit into a first region and a second region in the plurality of frames, and stores identification information for mutually identifying the plurality of frames in the first region, and stores transmission data in the second region.

### TECHNICAL FIELD

The present disclosure relates to a transmission device and a reception device.

### BACKGROUND ART

In energy storage devices, communication using the controller area network (CAN) protocol (hereinafter referred to as “CAN communication”) is used between a battery module and a management device that manages a plurality of battery modules. For example, Patent Literature (hereinafter, referred to as PTL) 1 discloses that communication via CAN is conducted between a battery module mounted on a mobile body such as an electric vehicle and an electric control unit (ECU) that controls various devices mounted on the mobile body.

In CAN communication, an identifier (ID) is assigned to each data frame (namely the unit of data transmission and reception) to identify a transmitting node (namely the sender) and the transmission data is stored in a data field (namely the data storage area in the data frame). The transmitting node, such as a battery module, transmits the data frame storing the transmission data to all nodes including the destination receiving node. On the other hand, the receiving node, such as a management device, receives the data frame transmitted from the transmitting node based on the ID assigned to the transmitted data frame and retrieves the transmission data stored in the data field.

### CITATION LIST

### Patent Literature

### PTL 1

WO2018/147046

### SUMMARY OF INVENTION

### Technical Problem

In CAN communication, usually only one data frame can be transmitted in a single transmission process. That is, in CAN communication, the number of frames and the data size that can be handled in a single transmission and reception process are also fixed. Therefore, for transmitting data larger than the size of the data field, it is necessary to use a plurality of frames to which different IDs are assigned and perform several transmission processes to transmit the data.

However, since there is a limit to the number of IDs that can be assigned to data frames, there is also a limit to the number of frames and the size of data that can be transmitted and received between devices. Therefore, when transmitting data corresponding data frames that exceeds the maximum number of IDs, there is a risk that there will be a shortage of IDs, making it impossible to transmit the data appropriately.

A purpose of the present disclosure is to provide transmission and reception devices that can appropriately transmit and receive data while suppressing the shortage of identifiers.

### Solution to Problem

A transmission device according to the present disclosure is a transmission device that stores transmission data while dividing the transmission data into a plurality of frames and transmits the frames, the transmission device including:
a frame generation unit that assigns a common identifier to the plurality of frames, divides a data field that is different from a storage of the identifier into a first area and a second area in each of the plurality of frames, stores identification information for identifying the plurality of frames from each other in the first area, and stores the transmission data in the second area.

In addition, a reception device according to the present disclosure is a reception device that receives transmission data divided and stored in a plurality of frames, the reception device including:
a data combination unit that refers to data fields each divided into a first area and a second area and combines the transmission data stored in the second areas according to identification information about the transmission data stored in the first areas, in the plurality of frames to which a common identifier is assigned.

### Advantageous Effects of Invention

According to the present disclosure, data can be appropriately transmitted and received while suppressing the shortage of identifiers.

### BRIEF DESCRIPTION OF DRAWINGS

FIG. 1 is a schematic diagram illustrating an example of the configuration of an energy storage device according to the present embodiment;

FIG. 2 is a functional block diagram illustrating an example of the configuration of the BMU in FIG. 1;

FIG. 3 is a schematic diagram for explaining a standard format data frame in CAN communication;

FIG. 4 is a schematic diagram for explaining the information stored in the data field;

FIG. 5 is a schematic diagram illustrating an example of the information contained in the transmission data transmitted and received between the BMU and the BMS;

FIG. 6 is a schematic diagram for explaining the data stored in a conventional data field; and

FIG. 7 is a schematic diagram for explaining the data stored in a data field of the present embodiment.

### DESCRIPTION OF EMBODIMENTS

Hereinafter, embodiments of the present disclosure will be described with reference to the drawings. The present disclosure is not limited to the following embodiments and can be variously modified without departing from the spirit of the present disclosure. The present disclosure also includes any combination of the configurations indicated in the following embodiments that can be combined. In the drawings, the same reference numerals denote the same or equivalent elements, which are common throughout the entire specification.

### Configuration of Energy Storage Device 1

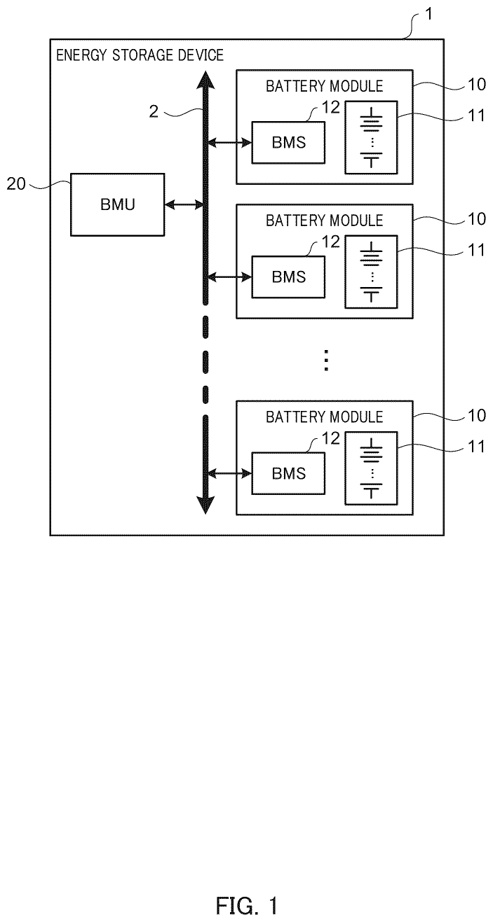

FIG. 1 is a schematic diagram illustrating an example of the configuration of energy storage device 1 according to the present embodiment. Energy storage device 1 stores electrical power supplied from an external power source (not illustrated) and supplies the stored electrical power to an electrical power supply target (not illustrated). As illustrated in FIG. 1, energy storage device 1 includes a plurality of battery modules 10 and battery management unit (BMU) 20. The plurality of battery modules 10 and BMU 20 are connected to bus 2.

### Battery Module 10

Battery module 10 includes secondary battery 11 and battery management system (BMS) 12.

Secondary battery 11 is composed of one or more secondary battery cells. When each secondary battery is composed of a plurality of secondary battery cells, the secondary battery cells are connected in series. Secondary battery 11 is, for example, a nickel-metal hydride secondary battery. The type of secondary battery 11 is not limited to this example and may be a secondary battery other than a nickel-metal hydride secondary battery, such as a lithium-ion secondary battery. In addition, a plurality of secondary batteries 11 may be provided, in which case the plurality of secondary batteries 11 are, for example, connected in series.

BMS 12 controls and monitors secondary battery 11 inside battery module 10. For example, BMS 12 monitors the voltage and temperature of secondary battery 11 based on detection results from various sensors (not illustrated). BMS 12 also monitors and controls the cell balance of the plurality of secondary battery cells based on the detection results.

Furthermore, BMS 12 communicates with BMU 20 via bus 2 and exchanges instruction information and battery information related to secondary battery 11 or battery module 10. The battery information is information related to a secondary battery, such as secondary battery 11 or battery module 10. The instruction information is information that includes, for example, a command for acquiring battery information related to secondary battery 11 or battery module 10 from BMS 12.

In the present embodiment, CAN is used as the communication protocol between BMS 12 and BMU 20. Details of CAN communication using the CAN protocol will be described below.

BMS 12 includes a central processing unit (CPU), a read only memory (ROM), and a random access memory (RAM), and the like (none of which are illustrated). The CPU reads a program corresponding to the processing content from the ROM, loads the program in the RAM, and centrally controls the operation of battery module 10 in cooperation with the loaded program.

### BMU 20

BMU 20 controls and manages a plurality of battery modules 10. For example, BMU 20 gives instructions for power-on and the like for each battery module 10, as well as instructions for fine-tuning the cell balance between battery modules 10. BMU 20 also performs CAN communication with BMS 12 of each battery module 10 via bus 2 and exchanges instruction information and battery information.

Furthermore, BMU 20 monitors the current of each battery module 10 based on detection results from sensors (not illustrated) and monitors overcharging and over-discharging for each battery module 10, for example. In addition, BMU 20 calculates the remaining capacity of the secondary battery based on the battery information.

BMU 20 includes a CPU, a ROM, and a RAM, and the like (none of which are illustrated). The CPU reads a program corresponding to the processing content from the ROM, loads the program in the RAM, and centrally controls the operation of energy storage device 1 in cooperation with the loaded program.

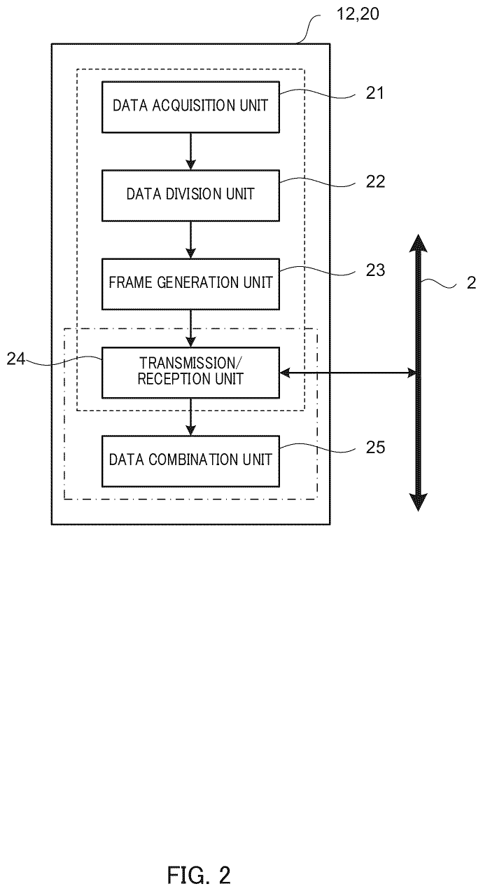

FIG. 2 is a functional block diagram illustrating an example of the configuration of BMU 20 in FIG. 1. FIG. 2 illustrates a processing unit for a function (among the functions of BMU 20) related to communication between BMU 20 and BMS 12. BMS 12 of each battery module 10 also has a communication-related function in the same manner as BMU 20 and has the configuration illustrated in FIG. 2. Here, BMU 20 will be described as an example.

As illustrated in FIG. 2, BMU 20 includes data acquisition unit 21, data division unit 22, frame generation unit 23, transmission/reception unit 24, and data combination unit 25.

Data acquisition unit 21 acquires, as transmission data, data including instruction information or battery information. Here, the instruction information or battery information included in the transmission data is classified by data category, and the transmission data transmitted and received in a single transmission and reception process includes instruction information or battery information of one common data category.

“Data category” is a rough classification of instruction information and battery information. For example, the instruction information and battery information include “voltage-related information” related to voltage and “temperature-related information” related to temperature, and the voltage-related information and temperature-related information correspond to the data categories referred to herein. Details of the data categories included in the instruction information and battery information will be described below.

Data division unit 22 divides the transmission data acquired by data acquisition unit 21 into a predetermined size and generates divided data. Specifically, data division unit 22 divides the transmission data into a size that can be stored in a data field—the data field is the data storage area of a data frame, which is the unit of data transmission and reception. The divided data is data obtained by dividing the transmission data of a common data category according to data content.

The “data content” is a more detailed classification of data that has been classified according to a data category. For example, data whose data category is classified as voltage-related information includes the current value and maximum voltage of the cell voltage of a secondary battery cell in secondary battery 11, and the current value and maximum voltage each correspond to the referred data content.

Frame generation unit 23 stores identification information and divided data in the data field of the data frame. The identification information is used to distinguish between a plurality of data frames. Details of the identification information will be described below. In addition, frame generation unit 23 assigns a common identifier, namely an ID, to a plurality of data frames corresponding to the number of pieces of divided data and generates the data frames.

Transmission/reception unit 24 performs transmission processing to transmit a data frame to another device connected to bus 2 from BMU 20 and also performs reception processing to receive a data frame from another device connected to bus 2. For example, transmission/reception unit 24 transmits a data frame including instruction information for BMS 12. In addition, transmission/reception unit 24 receives a data frame (in which battery information is stored) from BMS 12.

When data combination unit 25 receives a plurality of data frames from BMS 12 via transmission/reception unit 24, data combination unit 25 combines the data contained in the respective data frames based on the identification information, and restores the transmission data transmitted from BMS 12. When a plurality of data frames are received, it is not always necessary to combine the data frames to restore the transmission data. In that case, BMU 20 can simply receive the divided data contained in each data frame as is.

### CAN Communication

In the present embodiment, CAN communication used for data exchange between BMS 12 and BMU 20 will be described. As described above, in the present embodiment, CAN communication is used for exchanging information between BMS 12 and BMU 20. Herein, a standard format in CAN communication is taken as an example, and a data frame used during transmitting and receiving data, among frames used in CAN communication, will be described.

### Structure of Data Frame

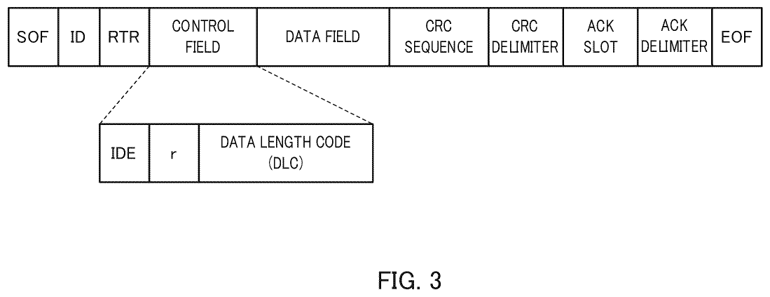

FIG. 3 is a schematic diagram for explaining a standard format data frame in CAN communication. As illustrated in FIG. 3, a data frame in CAN communication includes areas such as SOF (Start Of Frame), ID, RTR (Remote Transmission Request), control field, data field, CRC (Cyclic Redundancy Check) sequence, CRC delimiter, ACK (ACKnowledgement) slot, ACK delimiter, and EOF (End Of Frame).

The “SOF” area is 1 bit long and indicates the start of the data frame. The “ID” area is 11 bits long and is used to identify the content of the data and the sender. The ID area stores an ID, namely an identifier used to identify the data frame. The range of ID is 2048, from “0x0” to “0x7FF.” The “0x” at the beginning of the ID number indicates that the number is in hexadecimal notation. The “RTR” area is 1 bit long and is used to identify whether the frame is a data frame.

The “control field” area is 6 bits long and stores a 1-bit long IDE (Identifier Extension), a 1-bit long reserved bit r, and a 4-bit data length code (DLC: Data Length Code). The “IDE” is used to distinguish between a standard format and an extended format with an extended ID. The “reserved bit r” is used to distinguish between CAN and “CAN FD (CAN with Flexible Data rate)” which has an extended data field. The “DLC” indicates the length (byte long) of the data field following the control field. The DLC setting range is “0” to “8,” allowing the data field to store data from 0 to 8 bytes in 1-byte units.

The “data field” area is 0 to 8 bytes long and is the area where transmission data is stored. The data field can store data of a length set by the DLC.

The “CRC sequence” area is 15 bits long and is used to determine whether the data frame has been successfully received on the receiving side. Specifically, values are calculated on both the transmitting and receiving sides based on the SOF, ID, control field, and data field, and the normality of the data frame is determined by comparing both values. The “CRC delimiter” area is 1 bit long and indicates the end of the CRC sequence. The CRC sequence and CRC delimiter together are referred to as the “CRC field” area.

The “ACK slot” area is 1 bit long and is used to determine whether the data up to the CRC field portion has been successfully received. The “ACK delimiter” area is 1 bit long and indicates the end of the ACK slot. The ACK slot and ACK delimiter together are referred to as the “ACK field” area. The “EOF” area is 7 bits long and indicates the end of the data frame.

In CAN communication using such a standard format, generally, one data frame can be transmitted per transmission process. At this time, since the size of data that can be stored in the data field is up to 8 bytes, a plurality of data frames and corresponding IDs for the respective data frames are required to transmit data exceeding 8 bytes.

In the standard format of CAN communication, the ID range is “0x000” to “0x7FF,” and therefore, only 2048 IDs can be assigned to data frames. Therefore, when the size of the transmission data increases and it becomes necessary to transmit the transmission data using data frames in a number exceeding the maximum number of IDs, there will be a shortage of IDs and the data will no longer be able to be transmitted properly.

In this case, it is conceivable to change the format to an extended format that significantly increases the number of assignable IDs or to change the protocol to “CAN FD,” which extends the transmittable data size per frame to 64 bytes. However, changing the format or protocol in an existing system requires redesigning all devices related to CAN communication, making the changing difficult.

In the present embodiment, data can be appropriately transmitted and received within the range of the maximum number of IDs without changing the format or protocol. Specifically, in the present embodiment, a common ID is assigned to a plurality of data frames, and data frames in a number exceeding the maximum number of IDs are generated. In addition, each data frame is set with identification information about the transmission data to distinguish between data frames to which a common ID has been assigned.

### Data Field

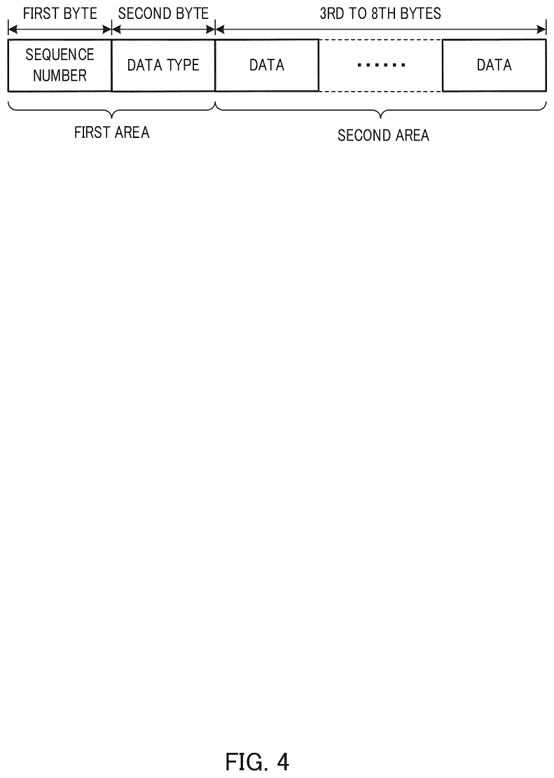

FIG. 4 is a schematic diagram for explaining the information stored in the data field. As illustrated in FIG. 4, in the present embodiment, a first area and a second area are set in the data field of the data frame is set.

The first area is an area that stores identification information to distinguish between a plurality of data frames and is the first 2 bytes of the data field, which can be up to 8 bytes. The first area stores the sequence number and data type as identification information.

The “sequence number” is identification information stored in the first byte of the data field. The sequence number is a number indicating the order of data frames assigned with a common ID when the transmission data is divided into pieces of divided data. In other words, the sequence number indicates the order of the pieces of the transmission data divided and respectively stored in the second areas of a plurality of data frames. For example, when the transmission data is divided into four pieces of divided data, sequence numbers “1” to “4” are assigned to the four data frames storing these divided data. These sequence numbers are each stored in the first byte of the data field according to the division order of the transmission data.

The “data type” is identification information stored in the second byte of the data field. The data type is a number indicating the content of the data stored in the second area. For example, when a plurality of data contents are included in the divided data, a different data type number is assigned to each data content and stored. More specifically, for example, when the divided data includes data with different data contents such as the current value and maximum voltage of the cell voltage, a data type “0” is assigned to the data indicating the current value of the cell voltage, and a data type “1” is assigned to the data indicating the maximum voltage.

The second area is a data storage area for storing transmission data and is the remaining area of up to 6 bytes excluding the first area of the data field. The second area stores the transmission data. Here, when the size of the transmission data exceeds the size of the second area, the divided data of the transmission data is stored in the second area.

The area where the sequence number and data type are stored is not limited to this example. For example, the data type may be stored in the first byte of the data field, and the sequence number may be stored in the second byte.

### Transmission and Reception of Data

In the following, the operation for transmitting and receiving data between the transmission device and the reception device will be described with reference to FIG. 2. Here, it is assumed that BMS 12 of battery module 10 functions as a transmission device and BMU 20 functions as a reception device, and the case where battery information regarding battery module 10 is transmitted from BMS 12 to BMU 20 will be described as an example.

For transmitting data from BMS 12 to BMU 20, first, data acquisition unit 21 of BMS 12 acquires data including battery information as transmission data. Then, data acquisition unit 21 supplies the acquired data as transmission data to data division unit 22.

When data division unit 22 receives the transmission data from data acquisition unit 21, data division unit 22 divides the transmission data to generate divided data when the size of the transmission data exceeds the size of the data field in the data frame (maximum 8 bytes). Specifically, data division unit 22 divides the transmission data, which is of a common data category, according to the data content. In addition, data division unit 22 divides the data so that the size of the divided data is a maximum of 6 bytes. Then, data division unit 22 supplies the divided data along with information indicating the number of divisions and data content to frame generation unit 23.

Frame generation unit 23 sets the sequence number based on the information indicating the number of divisions received from data division unit 22. In addition, frame generation unit 23 sets the data type based on the information indicating the data content received from data division unit 22. Furthermore, frame generation unit 23 stores the set sequence number and data type in the first area of the data field in each of a plurality of data frames.

Next, frame generation unit 23 stores the divided data received from data division unit 22 in the second area of the data field in each data frame, corresponding to the sequence number and data type. Then, frame generation unit 23 assigns a common ID to the plurality of generated data frames and supplies the plurality of data frames to transmission/reception unit 24.

Transmission/reception unit 24 sequentially transmits the plurality of data frames, to which the common ID has been assigned and which have been received from frame generation unit 23, to BMU 20 via bus 2. At this time, transmission/reception unit 24 transmits the plurality of data frames in the order of sequence numbers, for example. The transmission of a plurality of data frames is not limited to the above configuration; for example, as long as BMU 20 can reliably receive all data frames, to which a common ID is assigned thereto, the data frames may be transmitted in any order.

When there are data frames with the same ID on bus 2, errors may occur, or BMU 20 may miss receiving the data frames. Therefore, in the present embodiment, the transmission interval of a plurality of data frames is set to a level that ensures BMU 20 can reliably receive the data frames.

When BMU 20 receives data from BMS 12, transmission/reception unit 24 of BMU 20 receives the plurality of data frames to which a common ID has been assigned from BMS 12 via bus 2. In this case, transmission/reception unit 24 determines that the plurality of received data frames are of the same data category because they have a common ID, and supplies the plurality of received data frames to data combination unit 25.

Data combination unit 25 refers to the data fields in the plurality of acquired data frames and combines the data stored in the second areas of the data fields in the respective data frames according to the identification information stored in the first areas of the data fields.

First, data combination unit 25 extracts the sequence number and data type from each received data frame. Next, data combination unit 25 combines the divided data stored in the data fields of the plurality of data frames based on the extracted sequence number and data type to obtain the transmission data. Specifically, data combination unit 25 retrieves the divided data of the common data content based on the extracted data type. Then, data combination unit 25 combines the divided data according to the order of the sequence numbers corresponding to the retrieved divided data, respectively. As a result, the transmission data transmitted from BMS 12 is restored.

In this way, in the present embodiment, a common ID is assigned to a plurality of data frames, and divided data is stored in the data field of each frame, along with the sequence number and data type. This enables reduction of the number of IDs to be assigned during the transmitting and receiving of transmission data compared to the conventional method, thereby suppressing ID shortages.

On the other hand, when the size of the transmission data acquired by data acquisition unit 21 is 8 bytes or less, the transmission data can be stored in the data field of a single data frame, so there is no need to divide the data. In this case, data division unit 22 supplies the acquired data to frame generation unit 23 without dividing the data.

In addition, frame generation unit 23 does not set the sequence number and data type, and stores the transmission data in all areas composed of the first and second areas of the data field in the data frame. Then, frame generation unit 23 assigns an ID to the data frame and supplies the data frame to transmission/reception unit 24.

The configuration is not limited to the above, and even when the size of transmission data is less than or equal to the size of the data field in a data frame, the sequence number and data type may be set, and the transmission data may be divided. Specifically, for example, data division unit 22 divides the transmission data so that the size of the divided data is a maximum of 6 bytes, regardless of the size of the received transmission data, and generates divided data. In addition, frame generation unit 23 sets the sequence number based on the number of divisions of the transmission data and sets the data type based on the information indicating the data content.

As a result, regardless of the size of the transmission data, the setting of the sequence number and data type, as well as the process of dividing the transmission data, are performed, allowing the configuration of the device to be simplified.

### Examples

Next, a specific example will be given to explain the transmission data exchanged between BMU 20 and BMS 12. In this example, it is assumed that one BMU 20 is connected to seven battery modules 10 in energy storage device 1. In addition, it is assumed that each secondary battery 11 mounted on battery module 10 is composed of 12 secondary battery cells connected in series.

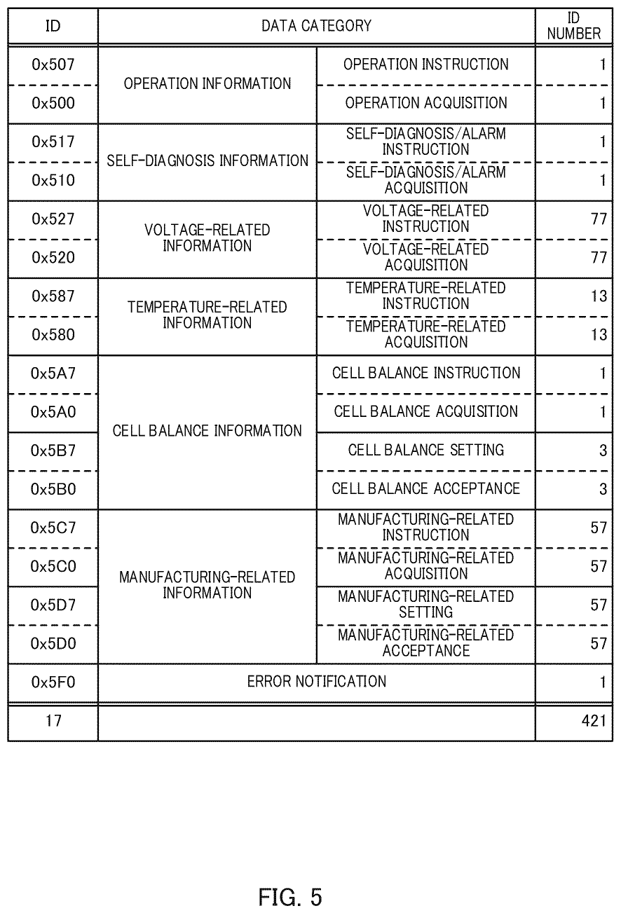

First, the instruction information and battery information transmitted and received between BMU 20 and BMS 12 will be described. FIG. 5 is a schematic diagram illustrating an example of the information included in the transmission data transmitted and received between BMU 20 and BMS 12. In FIG. 5, “Data category” indicates the type of information included in the transmission data. “ID” indicates the value of an ID assigned to a data frame that stores the information indicated by the corresponding data category in the present embodiment. “ID Number” indicates the number of IDs required when an ID is assigned to each data frame in the same manner as conventional CAN communication. The numerical values at the bottom of the “ID” and “ID Number” columns indicate the total numbers of IDs to be required to transmit information for all data categories.

As illustrated in FIG. 5, the instruction information and battery information include, as data categories, operation information, self-diagnosis information, voltage-related information, temperature-related information, cell balance information, manufacturing-related information, and error notification.

“Operation information” is information related to an operation such as the power-on of battery module 10. The operation information includes “operation instruction” transmitted from BMU 20 to BMS 12 as instruction information and “operation acquisition” transmitted from BMS 12 to BMU 20 as battery information. For transmitting and receiving “operation instruction” and “operation acquisition,” one ID is required for each.

“Self-diagnosis information” is information related to self-diagnosis of the state of battery module 10. The self-diagnosis information includes “self-diagnosis/alarm instruction” transmitted from BMU 20 to BMS 12 as instruction information and “self-diagnosis/alarm acquisition transmitted from BMS 12 to BMU 20” as battery information. For transmitting and receiving “self-diagnosis/alarm instruction” and “self-diagnosis/alarm acquisition,” one ID is required for each.

“Voltage-related information” is information related to a voltage, such as the voltage value of secondary battery 11 or a secondary battery cell in secondary battery 11. The voltage-related information includes “voltage-related instruction” transmitted from BMU 20 to BMS 12 as instruction information and “voltage-related acquisition” transmitted from BMS 12 to BMU 20 as battery information. For transmitting and receiving “voltage-related instruction” and “voltage-related acquisition,” 77 IDs are required for each.

“Temperature-related information” is information related to a temperature, such as the temperature of secondary battery 11 or a secondary battery cell in secondary battery 11. The temperature-related information includes “temperature-related instruction” transmitted from BMU 20 to BMS 12 as instruction information, and “temperature-related acquisition” transmitted from BMS 12 to BMU 20 as battery information. For transmitting and receiving “temperature-related instruction” and “temperature-related acquisition,” 13 IDs are required for each.

“Cell balance information” is information related to the cell balance among the secondary battery cells forming secondary battery 11. The cell balance information includes “cell balance instruction” and “cell balance setting” transmitted from BMU 20 to BMS 12 as instruction information, and “cell balance acquisition” and “cell balance acceptance” transmitted from BMS 12 to BMU 20 as battery information. For transmitting and receiving “cell balance instruction” and “cell balance acquisition,” 1 ID is required for each. In addition, for transmitting and receiving “cell balance setting” and “cell balance acceptance,” 3 IDs are required for each.

“Manufacturing-related information” is information related to battery module 10 and secondary battery 11, as well as manufacturing information such as a serial number. The manufacturing-related information includes “manufacturing-related instruction” and “manufacturing-related setting” transmitted from BMU 20 to BMS 12 as instruction information, and “manufacturing-related acquisition” and “manufacturing-related acceptance” transmitted from BMS 12 to BMU 20 as battery information. For transmitting and receiving “manufacturing-related instruction,” “manufacturing-related acquisition,” “manufacturing-related setting,” and “manufacturing-related acceptance,” 57 IDs are required for each.

“Error notification” is information transmitted from BMS 12 to BMU 20 as battery information when an abnormality occurs in battery module 10. For transmitting and receiving “error notification,” 1 ID is required.

Next, the case of transmitting and receiving instruction information or battery information between one BMU 20 and one BMS 12 will be considered. As illustrated in FIGS. 5, 421 IDs are usually required for transmitting and receiving instruction information or battery information for all data categories between one BMU 20 and one battery module 10 (BMS 12).

However, since the total number of IDs available for standard format CAN communication is 2048, the number of IDs available for one BMS 12 is 292(=2048/7 ). Therefore, when different IDs are assigned to all data frames to be transmitted and received, there will be a shortage of IDs, and it will not be possible to transmit and receive information for all data categories.

In contrast, in the present embodiment, during transmitting and receiving information for each data category, a common ID is assigned to a plurality of data frames. Therefore, only one ID is required during transmitting and receiving information for each data category. Thus, for transmitting and receiving information for all data categories, only 17 IDs need to be used.

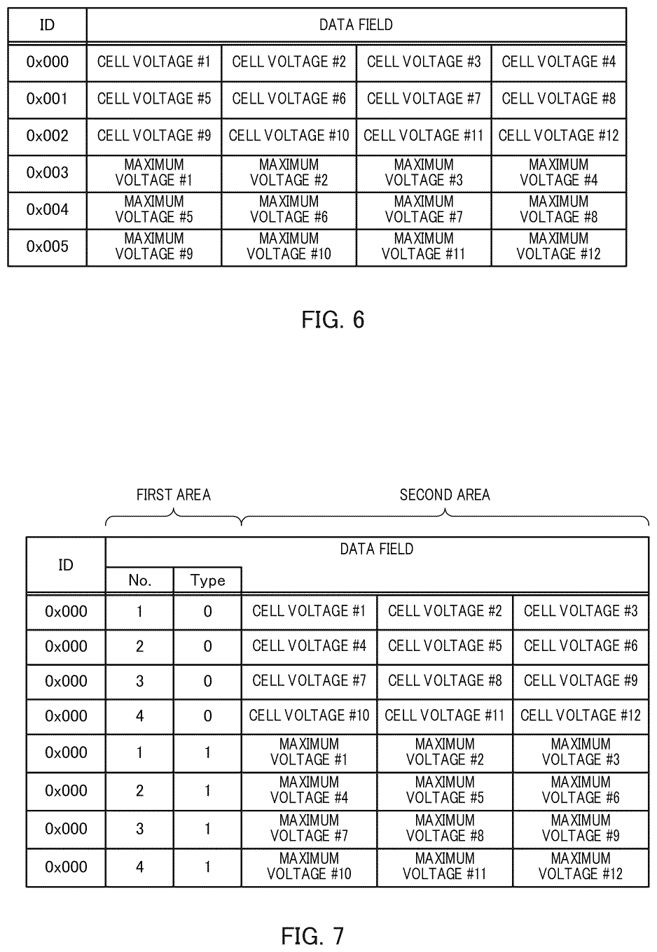

In the following, the relationship between the data stored in a data field of a data frame and an ID will be described. FIG. 6 is a schematic diagram for explaining the data stored in a conventional data field. FIG. 7 is a schematic diagram for explaining the data stored in a data field of the present embodiment. Here, a case where transmitting data including cell voltages #1 to #12 and maximum voltages #1 to #12 of 12 secondary battery cells is transmitted as transmission data will be describes as an example. In the examples of FIG. 6 and FIG. 7, “cell voltage” indicates the “current value of the cell voltage.”

As illustrated in FIG. 6, conventionally, divided data of transmission data is stored in all areas of a data field. For example, when transmission data including the cell voltages #1 to #12 of 12 battery cells and the maximum voltages #1 to #12 of these battery cells is divided and transmitted, six data frames would have been required in a conventional art. Then, different IDs (0x000 to 0x005) would be assigned to each data frame. That is, 6 IDs are required to transmit such transmission data in the conventional art.

In contrast, in the present embodiment, the sequence number and data type are stored in the first area of a data field, and the divided data is stored in the second area, as illustrated in FIG. 7. For example, in the same manner as the example illustrated in FIG. 6, when transmission data including the cell voltages #1 to #12 and the maximum voltages #1 to #12 is divided and transmitted, the present embodiment requires 8 data frames, i.e., more than required in the conventional art.

However, since the sequence number and data type are stored in the first area of each data field, each data frame can be individually identified, allowing a common ID (0x000) to be assigned to the data frames. That is, in the present embodiment, only one ID is required to transmit this transmission data.

Thus, in the present embodiment, the number of IDs required to transmit transmission data of the same size can be reduced compared to the conventional art. Therefore, even when it is necessary to transmit a plurality of data frames exceeding the number of available IDs, the data frames can be transmitted while suppressing ID shortage.

As described above, when BMS 12 or BMU 20 as a transmission device according to the present embodiment divides transmission data into a plurality of data frames, stores the data frames, and transmits the data frames, BMS 12 or BMU 20 assigns a common ID to the plurality of data frames. In addition, BMS 12 or BMU 20 divides the data field into a first area and a second area in each of a plurality of data frames, and stores the sequence number and data type (namely identification information) in the first area and the transmission data in the second area.

Thus, since the divided pieces of data of transmission data are stored in a plurality of data frames (to which a common ID has been assigned) and transmitted, the transmission data can be appropriately transmitted. Furthermore, since a common ID is assigned to a plurality of data frames, ID shortage can be suppressed.

Moreover, when BMU 20 or BMS 12 as a reception device according to the present embodiment receives transmission data, BMU 20 or BMS 12 refers to the data field divided into a first area and a second area in each of the plurality of data frames to which a common ID has been assigned. Then, BMU 20 or BMS 12 combines the pieces of transmission data stored in the second areas according to the sequence number and data type (which are identification information about the transmission data) stored in each first area.

Thus, the transmission data (which is divided into pieces and stored in the second areas of a plurality of data frames and a common ID has been assigned to the pieces) is combined based on the identification information stored in the first areas, allowing the transmission data to be appropriately received.

While the present embodiment has been described, the present disclosure is not limited to the above-described embodiment, and various modifications and applications are possible without departing from the gist of the present disclosure. In the present embodiment, the application of CAN as a communication protocol has been described, but the present disclosure is not limited thereto, and the present disclosure can also be applied to communication standards using protocols where only one frame with a unique ID can be transmitted in one transmission and the IDs are finite.

This application is entitled to and claims the benefit of Japanese Patent Application No. 2023-007034, filed on Jan. 20, 2023, the disclosure of which including the specification, drawings and abstract is incorporated herein by reference in its entirety.

### REFERENCE SIGNS LIST

1 Energy storage device
2 Bus
10 Battery module
11 Secondary battery
12 BMS
20 BMU
21 Data acquisition unit
22 Data division unit
23 Frame generation unit
24 Transmission/reception unit
25 Data combination unit

1. A transmission device that stores transmission data while dividing the transmission data into a plurality of frames and transmits the frames, the transmission device comprising:
a frame generation unit that assigns a common identifier to the plurality of frames, divides a data field that is different from a storage of the common identifier into a first area and a second area in each of the plurality of frames, stores identification information for identifying the plurality of frames from each other in the first area, and stores the transmission data in the second area.

2. The transmission device according to claim 1, wherein
the identification information includes a sequence number indicating an order of pieces of the transmission data respectively stored in the second areas in the plurality of frames.

3. The transmission device according to claim 2, further comprising:
a transmission unit that transmits the plurality of frames according to the order indicated by the sequence number.

4. The transmission device according to claim 1, wherein
the frame generation unit assigns the common identifier to the plurality of frames storing the transmission data of a common data category.

5. The transmission device according to claim 1, wherein:
the transmission data of a common data category includes the transmission data of data contents different to each other; and
the identification information includes a data type number indicating a corresponding one of the data contents of the transmission data.

6. The transmission device according to claim 1, wherein the transmission data includes data related to a secondary battery.

7. A reception device that receives transmission data divided and stored in a plurality of frames, the reception device comprising:
a data combination unit that refers to data fields each divided into a first area and a second area and combines the transmission data stored in a plurality of the second areas according to identification information about the transmission data stored in a plurality of the first areas, in the plurality of frames to which a common identifier is assigned.
